(19) United States
(12) Patent Application Publication
(10) Pub. No.: US 2026/0039623 A1
(43) Pub. Date: Feb. 5, 2026

(54) METHODS, SYSTEMS, AND APPARATUS FOR IDENTIFYING A DEVICE/USER BEHIND A RESIDENTIAL GATEWAY AND FOR HANDLING UNRECOGNIZED DEVICES

(71) Applicant: InterDigital Patent Holdings, Inc., Wilmington, DE (US)

(72) Inventors: Debashish Purkayastha, Eagleville, PA (US); Xavier De Foy, Kirkland (CA); Michael Starsinic, Newtown, PA (US); Anuj Sethi, Ottawa (CA); Samir Ferdi, Kirkland (CA)

(73) Assignee: InterDigital Patent Holdings, Inc., Wilmington, DE (US)

(21) Appl. No.: 18/793,606

(22) Filed: Aug. 2, 2024

(51) Int. Cl. H04L 61/5014; H04W 76/10

(52) U.S. Cl. CPC H04L 61/5014; H04W 76/10

(57) ABSTRACT

Systems, methods, and apparatus may be provided for identifying a device or user behind a resential gateway. For example, a wireless transmit/receive unit (WTRU) may perform a method that may comprise a number of operations. A Protocol Data Unit (PDU) session to a network node may be established. A first message may be received from a device. The first message may indicate a Dynamic Host Configuration protocol (DHCP) request. A device identifier associated with the DHCP request may be determined based on configuration information and a characteristic of the DHCP request. A second message may be generated. The second message may indicates the DHCP request and a remote identification (ID) option value. The remote ID option value may be set to the device identifier. The second message may be sent to the first network node using the first PDU session.

### BACKGROUND

Mobile communications using wireless communication continue to evolve. A fifth generation may be referred to as 5G. A previous (legacy) generation of mobile communication for example, may be fourth generation (4G) long term evolution (LTE).

### SUMMARY

Systems, methods, and apparatus may be provided for identifying a device or user behind a residential gateway. For example, a wireless transmit receive unit (WTRU) may perform a method that may comprise a number of operations. A Protocol Data Unit (PDU) session to a network node may be established. A first message may be received from a device. The first message may indicate a Dynamic Host Configuration protocol (DHCP) request. A device identifier associated with the DHCP request may be determined based on configuration information and characteristics of the DHCP request. A second message may be generated. The second message may indicate the DHCP request and a remote identification (ID) option value. The remote ID option value may be set to the device identifier. The second message may be sent to the first network node using the first PDU session.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flow diagram illustrating an example procedure for a Dynamic Host Configuration Protocol version 6 (DHCPv6) based Quality of Service (QoS) update via the Policy Control Function (PCF).

FIG. 3 is a flow diagram illustrating an example procedure that may occur after receiving a DHCPv6 message.

### DETAILED DESCRIPTION

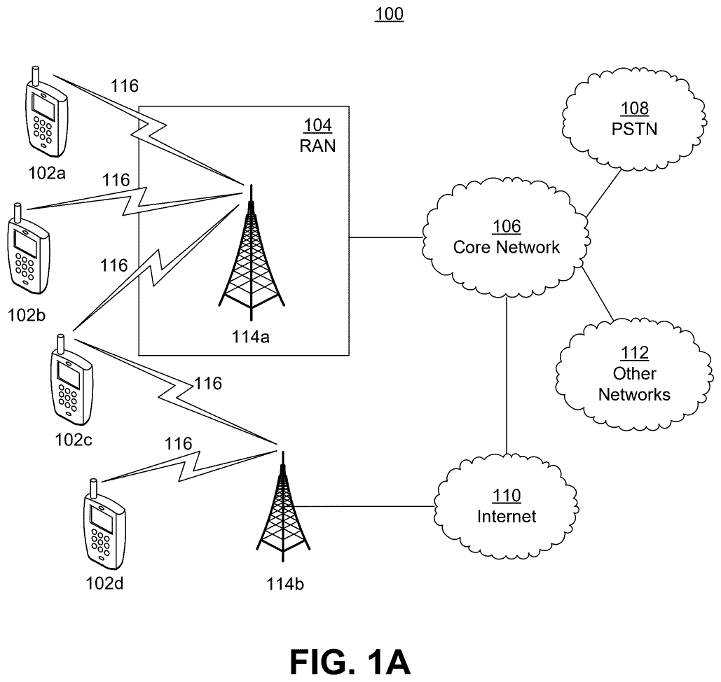

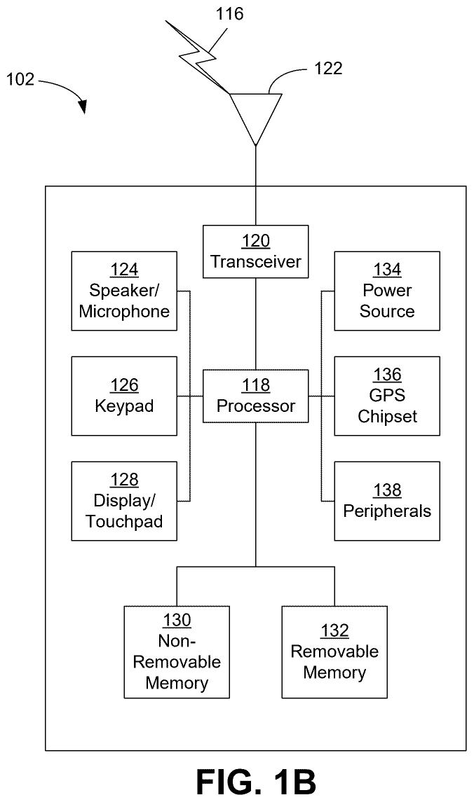

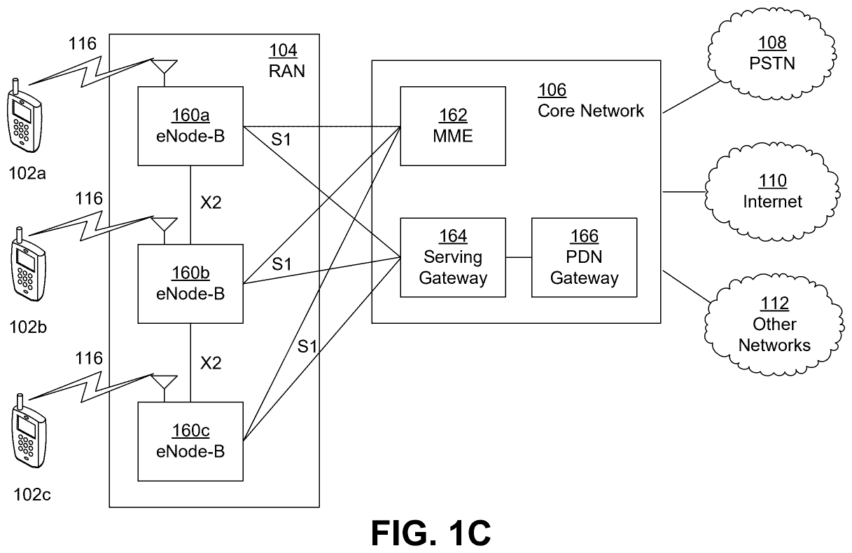

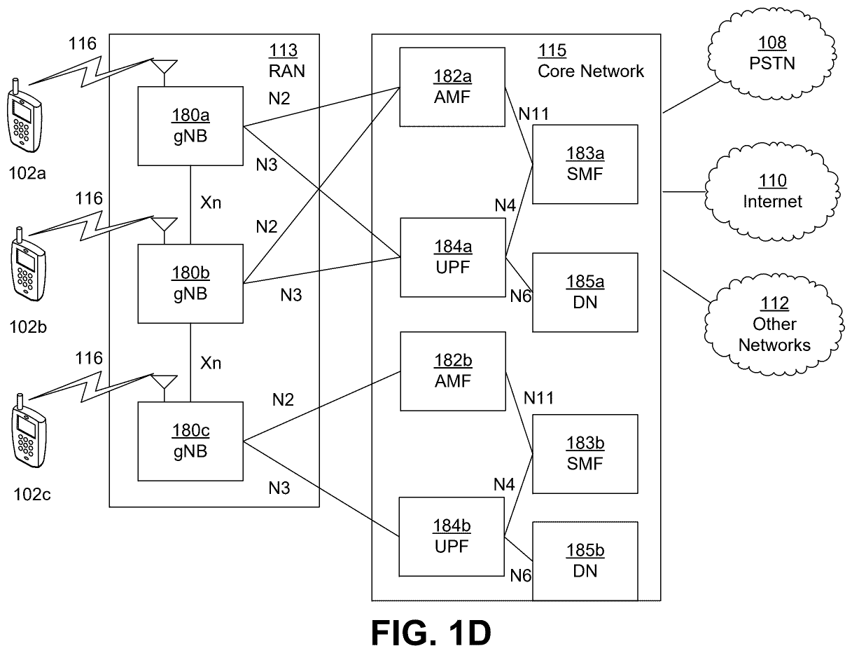

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example, in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

Systems, methods, and apparatus may be provided for identifying a device or user behind a residential gateway. For example, a wireless transmit/receive unit (WTRU) may perform a method that may comprise a number of operations. A Protocol Data Unit (PDU) session to a network node may be established. A first message may be received from a device. The first message may indicate a Dynamic Host Configuration protocol (DHCP) request. A device identifier associated with the DHCP request may be determined based on configuration information and one or more characteristics of the DHCP request. A second message may be generated. The second message may indicate the DHCP request and a remote identification (ID) option value. The remote ID option value may be set to the device identifier. The second message may be sent to the first network node using the first PDU session.

In an example, a third message may be received from the network node. The third message may indicate a DHCP response. The DHCP response may indicate an error code. A fourth message may be sent to the device. The fourth message may indicate the DHCP response.

In an example, the PDU session may be a first PDU session, the network node may be a first network node, and the DHCP request may be a first DHCP request. A second PDU session may be established with a second network node. A sixth message may be received from the device. The sixth message may indicate a second DHCP request. It may be determined that the second DHCP request is associated with the error code. A seventh message may be sent to the second network node using the second PDU session.

In an example, the second PDU session may be selected based on a determination that the first PDU session is associated with the error code.

In an example, the DHCP response may be a first DHCP response. An eighth message may be received from the second node. The either message may indicate a second DHCP response. The second DHCP response may indicate an acknowledgement that the seventh message was received. A ninth message may be sent to the device. The ninth message may indicate the second DHCP response.

In an example, data may be received from the second network node using the second PDU session and the data may be sent to the device.

In an example, data may be received from the device and may be sent to the second network node using the second PDU session.

In an example, configuration information may be determined. For example, configuration information may be received via a graphical user interface (GUI).

In an example, the second message may be sent to the network node using the PDU session. The first PDU session may be selected based on the configuration information. The first PDU session may be used for sending the second message based on the configuration information. The second message may be sent to the first network node using the selected PDU session.

In an example, the error code may comprise at least one of an indication of a failure cause, an indication that the device identifier is not recognized, an indication that the device identifier is not linked to a subscription associated with the WTRU, an indication that the device identifier is not permitted to access the first PDU session, or an indication that the device identifier is not permitted to access the second PDU session.

In an example, the configuration information may be a first configuration information. The first configuration information may be determined. The first configuration information may be associated with a first Data Network Name (DNN) and a second Single-Network Slice Selection Assistance Information (S-NSSAI). A combination of the first DNN and the first S-NSSAI may indicate one or more devices that request at least one of a device specific Quality of Service (QoS) or a device identifier.

In an example, the configuration information may be a first configuration information. A second configuration information may be determined. The second configuration information may be associated with a second DNN and a second S-NSSAI. A combination of the second DNN and the second S-NSSAI may indicate one or more devices that are not associated with at least a device specific QoS or a device identifier.

The terms residential gateway (RG), 5G-RG, RG/UE, and RG/WTRU may be used interchangeably. In an example, an RG may be a type of UE. In an example, an RG may be a type of WTRU.

The device identifier may refer to an identifier of a device (e.g., non-3GPP device) or a WTRU. The device (e.g., non-3GPP device) or WTRU may use an RG to connect to a system, such as a 5G system. The device identifier may be called a user identifier. The format of the device identifier may be an NAI or a string.

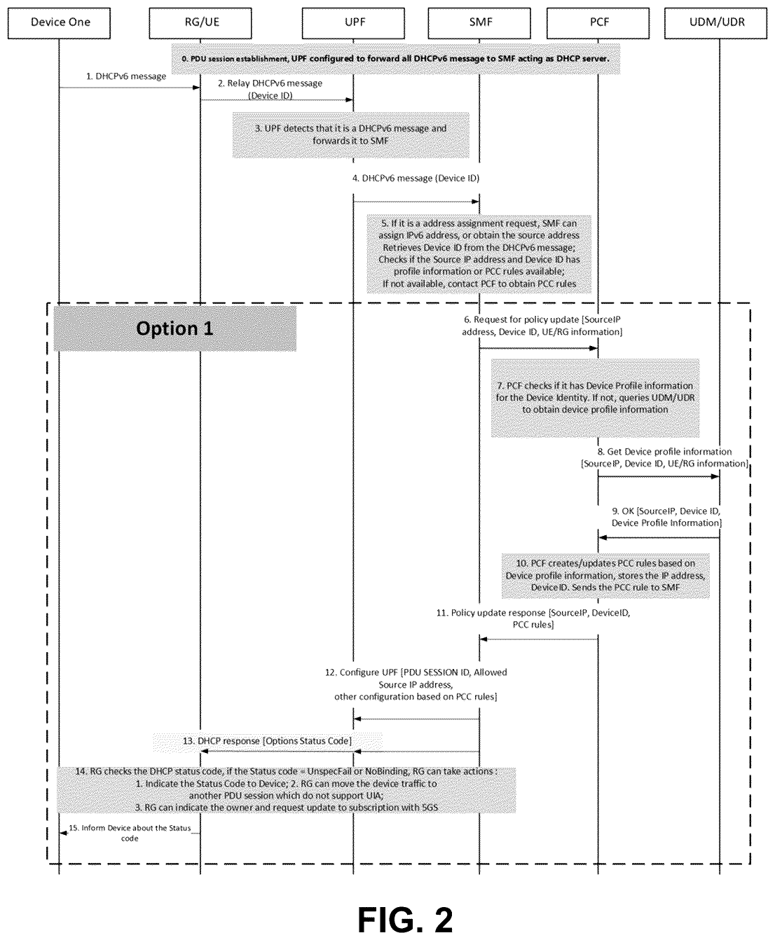

In an example, one or more RG actions performed by a device of a specific QoS may not be permitted by the Network. FIG. 2 is a flow diagram illustrating an example procedure for a Dynamic Host Configuration Protocol version 6 (DHCPv6) based Quality of Service (QoS) update via the Policy Control Function (PCF).

At 0, a first Packet Data Unit (PDU) session may be established. The first PDU session may be associated with a first data network name (DNN) and/or single-network slice selection assistance information (S-NSSAI). As described herein, a DNN and/or a S-NSSAI may be referred to as a DNN/S-NSSAI or a DNN/S-NSSAI combination. In an example, the first PDU session may be associated with a first DNN/S-NSSAI combination. The WTRU may be configured with information that indicates that the first DNN/S-NSSAI is associated with devices that request (e.g., require) a device specific QoS treatment. The WTRU may be configured with information that indicates the first DNN/S-NSSAI combination is associated with devices that are associated with device identifiers.

At 0, a second PDU session may be established. The second PDU session may be associated with a second DNN/S-NSSAI combination. The WTRU may be configured with information that indicates that the second DNN/S-NSSAI combination is associated with devices that do not request (e.g., require) a device specific QoS treatment. The WTRU may be configured with information that indicates that the second DNN/S-NSSAI combination is associated with devices that are not associated with device identifiers.

At 1, a request (e.g., a DHCPv6 request) may be received from a device.

At 2, based on configuration information, it may be determined that the device is associated with a device identifier. The configuration information may be received via a graphical user interface (GUI).

At 2, a REMOTE ID option may be added to the request (e.g., a DHCPv6 request). The REMOTE ID option value may be set to the value of the device identifier. The request (e.g., the DHCPv6 request) may be sent using the first PDU session. The first PDU session may be selected based on the configuration information indicating that the device is associated with a device identifier.

At 5, a response, such as a DHCPv6 Response, may be received. The response may include an error code. The error code may indicate NoBinding, UnspecFail, or another failure cause. The error code may be indicative of the device identifier not being recognized. The error code may be indicative of the device identifier not being linked to the subscription of the RG. The error code may be indicative of the device identifier not being permitted to access a PDU session that is associated with the first DNN/S-NSSAI combination. The error code may be indicative of the device identifier not being permitted to the first PDU session.

At 15, the response may be sent to the device. For example, the DHCPv6 response may be sent to the device.

At 14, a second request may be received from the device. For example, a second DHCPv6 Request may be received from the device.

At 14, based on receiving the error code, it may be determined that the device is not associated or not to be associated with a device identifier. The configuration information may be disregarded, for example, based on the received error code.

At 14, the request, which may be a DHCPv6 request, may be sent using the second PDU session without adding a REMOTE ID option to the request. The second PDU session may be selected based on the received error code. The configuration information that indicates that the device is associated with a device identifier may be disregarded based on the received error code.

At 14, a second response, which may be a DHCPv6 Response, may be received. The second response may not include an error code (e.g., may indicate that there are no errors, or that the second request was successfully received).

At 14, the second response (e.g., second DHCPv6 response) may be forwarded to the device.

At 14, the second PDU session may be used to route traffic to and/or from the device.

User Plane Function(s) may handle the user plane path of PDU sessions. Deployments may be supported with a single UPF or multiple UPFs for a given PDU session.

For an IPv4 type PDU session, an IPv6 type PDU session without multi-homing, or an IPv4v6 type PDU session, if multiple PDU session Anchors are used (e.g., due to uplink (UL) Classifier (CL) being inserted), one (e.g., only one) IPv4 address and/or IPv6 prefix may be allocated for the PDU session. For an IPv6 multi-homed PDU session there are multiple IPv6 prefixes allocated for the PDU session.

User Plane Function (UPF) traffic detection capabilities may be used by the Session Management Function (SMF) to control at least one of the following features of the UPF: traffic detection (e.g., classifying traffic of IP type, Ethernet type, or unstructured type), traffic reporting (e.g., allowing SMF support for charging), QoS enforcement, or traffic routing.

During a PDU session establishment procedure, the SMF may send an IP address to the WTRU via Session Management (SM) non-access stratum (NAS) signaling. The IPv4 address allocation and/or IPv4 parameter configuration via DHCPv4 may also be used when the PDU session is established. IPv6 prefix allocation may be supported via stateless auto-configuration (e.g., IPv6 Stateless Auto-configuration), if IPv6 is supported.

An Internet Protocol (IP) PDU session may be provided. During the lifetime of a PDU session, the WTRU may acquire at least one of the following configuration information from the SMF: address(es) of P-CSCF(s), address(es) of a domain name server(s) (DNS), a combination thereof, or the like.

If the WTRU indicates support of DNS over (D) transport layer security (TLS) to the network and the network wants to enforce the use of DNS over (D) TLS, the configuration information sent by the SMF via PCO may also include the corresponding DNS server security information.

The WTRU may acquire the Maximum Transmission Unit (MTU) size (e.g., the MTU considered by the WTRU) from the SMF, at PDU session establishment.

An Ethernet PDU session type may be provided. For a PDU session set up with the Ethernet PDU session type, the SMF and the UPF may act as a PDU Session Anchor (PSA) and may support specific behaviors related to the fact that the PDU session carries Ethernet frames.

Configurations with a 1-1 relationship between a PDU session and an N6 interface may be provided. These configurations may correspond to a dedicated tunnel established over N6. The UPF may act as a PSA and transparently forward Ethernet frames between the PDU session and its corresponding N6 interface. The UPF may not be (e.g., need not be) aware of MAC addresses used by the WTRU to route downlink traffic.

Configurations, where more than one PDU session to the same DNN (e.g., for more than one WTRU) corresponds to the same N6 interface, may be provided. The UPF acting as the PSA may be aware of MAC addresses used by the WTRU in the PDU session to map down-link Ethernet frames received over N6 to the appropriate PDU session. The forwarding behavior of the UPF acting as the PSA may be managed by the SMF.

An RG that may connect to a system, such as a 5G system, may be provided. In an example, the RG may be a WTRU.

For examples or scenarios where an RG connects to a core network (e.g., a 5GC), additional features for IPv6 address allocation and IPv6 prefix delegation may be supported. One or more non-3GPP devices may connect to a core network (e.g., 5GC) through a WTRU or RG (e.g., 5G-RG). These devices (e.g., non-3GPP devices) may be called devices behind RG. To provide policy control for the traffic from these devices (e.g., non-3gpp devices), each device may (e.g., may need to) be identified.

A WTRU, such as an RG, may serve as a gateway to devices (e.g., non-3GPP devices) that connect to the WTRU. In examples, the devices may connect to the WTRU using protocols such as Wi-Fi or ethernet. The WTRU may establish a PDU session to send traffic that originates from the devices and to receive traffic that is forwarded to them. The traffic from the devices may be IP based traffic. The PDU session type may be IP.

To support IPv6 address/prefix allocation for devices behind RG, the SMF may act as a DHCPv6 server, and the RG may act as a DHCPv6 relay. Devices behind RG may send IPv6 messages to RG, which may relay the message to the SMF acting as DHCPv6 server via the UPF.

Devices behind RG may engage in a message exchange, which may be a DHCPv6 message exchange. The message exchange may involve one or more of the following messages:
Solicit—sent by a DHCPv6 Client to locate DHCPv6 servers;
Advertise—sent by a DHCPv6 server to a DHCPv6 Client in answer to the solicit message as an affirmative message that DHCPv6 Server services are available to a DHCPv6 Client;
Request—sent by a DHCPv6 Client to a DHCPv6 Server to request configuration parameters;
Reply—sent by a DHCPv6 Server to a DHCPv6 Client with configuration information; and.
Renew—sent by a DHCPv6 Client to a DHCPv6 Server requesting an extension to the address lifetime.

DHCP Options may be used to carry additional information and parameters in DHCP messages. In an example, a DHCP option may refer to a field in a DHCP protocol message. In an example, an option may be referred to by its number, such as 18. In an example, an option may be Interface-ID Option (which may be an option that is identifed by the number 18). The RG acting as a relay agent may send the interface-ID option to identify the interface on which the client message was received. The RG may add an interface ID to a DHCP request that came from a device before forwarding the DHCP request to the SMF. If a relay agent receives a relay-reply message with an interface-ID option, the relay agent may relay the message to the client through the interface identified by the option. Servers may use the interface-ID field for parameter assignment policies. The interface-ID value may be considered an opaque value relay, with policies based on a match (e.g., exact match only). A value that is opaque relay agent may not need to be interpreted by the relay agent, for example, the relay agent may only need to forward the value.

In an example, the Relay Agent Remote-ID Option (37) may be added by DHCPv6 relay agents that terminate switched or permanent circuits and have mechanisms to identify the remote host end of the circuit.

In an example, a remote ID option may consist of at least one of an enterprise number, a remote ID, a combination thereof, or the like. The enterprise number may be a vendor's registered enterprise number as registered with the Internet Assigned Numbers Authority (IANA). The remote ID may be an opaque value to the relay agent.

In an example, a remote ID carried in an option, such as Relay Agent Remote-ID Option (the option that is identified by the number 37). The value that is indicated in the Relay Agent Remote-ID field may be vendor-specific. The vendor may use the field to indicate an enterprise-number field. The remote ID field may be used to encode, at least one or more of the following: a caller ID telephone number for dial-up connection, a username prompted for by a Remote Access Server, a remote caller ATM address, a modem ID of a cable data modem, the remote IP address of a point-to-point link, a remote X.25 address for X.25 connections, an interface or port identifier, a combination thereof, or the like.

A vendor (e.g., each vendor) may ensure that the remote-ID is unique for its enterprise-number, as the octet sequence of enterprise-numbers followed by remote-ID may be globally unique. In an example, uniqueness may be achieved by including the relay agent's DHCP Unique Identifier (DUID) in the remote-ID.

The RG may add a remote ID to a DHCP request from a device before forwarding the DHCP Request to the SMF.

An RG acting as a relay agent, may include these options (e.g., the interface ID and remote ID) in DHCPv6 relay forward message towards the SMF acting as DHCPv6 server.

The DHCPv6 server may use a status code to indicate a status indication related to the DHCP message or option in which it appears. A status code option may appear as a status indication of a DHCP message and/or in the options field.

The status-code values may be at one or more of the following:

| Name | Code | Description |
|---|---|---|
| Success | 0 | Success. |
| UnspecFail | 1 | Failure, reason unspecified; this status |
| | | code is sent by either a client or a |
| | | server to indicate a failure not |
| | | explicitly specified. |
| NoAddrsAvail | 2 | The server has no addresses available |
| | | to assign to the IA(s). |
| NoBinding | 3 | Client record (binding) unavailable. |
| NotOnLink | 4 | The prefix for the address is not |
| | | appropriate for the link to which the |
| | | client is attached. |
| UseMulticast | 5 | Sent by a server to a client to force the |
| | | client to send messages to the server |
| | | using the |
| | | All_DHCP_Relay_Agents_and_Servers |
| | | multicast address. |
| NoPrefixAvail | 6 | The server has no prefixes available to |
| | | assign to the IA_PD(s). |

In an example, the status code NoBinding may be included in the option remote ID sent by the DHCP server (e.g., SMF, to the Relay Agent, for example, the RG).

If the SMF acts as the DHCPv6 server towards the WTRU (e.g., assuming a PDU session anchor UPF does not have any related DHCP functionality), the SMF may instruct the PDU session anchor UPF serving the PDU session to forward one or more (e.g., all) DHCPv6 packets between the WTRU and the SMF over the user plane.

Authentication and authorization in a system, such as a 5G system, may be provided. The system, such as the 5G system, may define security solutions, which may include primary and secondary authentication. Primary authentication may offer at least two mechanisms: Authentication and Key Agreement (AKA), and Extensible Authentication Protocol AKA′ (EAP-AKA′).

In an example, Home Control may be provided. Home Control may be where authentication takes place in the home network. A Subscription Concealed Identifier (SUCI) may be provided in the signaling to prevent the exposure of a permanent subscriber ID, which may ensure user privacy. This may be different when compared to a Subscription Permanent Identifier (SUPI), which may have the format of a traditional International Mobile Subscription Identifier (IMSI). Secondary authentication may provide a mechanism for external network to authenticate the user as part of the PDU session establishment, with the support of mobile operator.

Embodiments described herein may provide further enhancements and additional security features. In an example, one or more authentication procedures may be used. In an example, a network slice may be used to provide authentication at a network slice level. In an example, Authentication and Key Management for Applications based on 3GPP credentials in 5G (AKMA) may be used. In an example, a bootstrapping architecture, such as AKMA, may be used enhance the Generic Bootstrapping Architecture (GBA)-based solution of a system, such as a 4G or 3G system.

The EAP-AKA may be an extensible authentication protocol (EAP) method for authentication and session key distribution that may use an AKA mechanism. Authentication and Key Agreement (AKA) may be based on challenge-response mechanisms and symmetric cryptography. AKA may run using credentials (K) stored in a Universal Subscriber Identity Module (USIM).

Based on EAP-AKA, EAP-AKA′ may be a variant of EAP-AKA, that may be used for both 3GPP and non-3GPP access to a core network, such as a 3GPP core network. EAP-AKA′ may use credentials (K) stored in the USIM card and a challenge-response mechanism to verify the user's identity. It may also produce cryptographic keys used for encryption in a secure Wi-Fi network (e.g., 802.1x).

Authenticable devices (e.g., non-3GPP and 3GPP) (e.g., WTRU or N5CW devices) behind the Residential Gateway (RG) may connect to a 3GPP network. Authenticable non-3GPP (AUN3) device connecting to RG in a PLMN are registered to the 5GC by the 5G-RG or W-AGF and is authenticated by 5GC using EAP-AKA′.

In an example, the RG may initiate the EAP authentication procedure by sending an EAP request/Identity to the AUN3 device. The AUN3 device may send back an EAP response/identity, including its Network Access Identifier (NAI), in the form of username@realm, for example. If the RG is a 5G-RG, the 5G-RG may construct an SUCI from the NAI-based SUPI of the AUN3 device and may send a NAS Registration Request message to the AMF, including the SUCI and an AUN3 device indicator. Authentication mechanisms may be based on the subscription identifier like SUCI, SUPI, etc. related to the WTRU subscription. Users or applications using the WTRU may not be identified.

Devices behind RG may have a device identity or device identifier. The device identity or device identifier may be equivalent to interface ID, port ID, or other forms of identifiers. These device identities may be provided to an SMF by including them in messages (e.g., DHCPv6 messages).

The RG may use DHCPv6 to provide the network with a device identifier, which the network can use to determine device-specific QoS Rules.

Whether and how the system, such as the 5GS, provides a device behind an RG, acting as a DHCPv6 relay, with connectivity to the system when the device is not recognized by the system and device-specific QoS treatment is not available is provided.

A Residential Gateway (RG) may be a WTRU that provides connectivity to other WTRUs and devices (e.g., non-3GPP devices). The connectivity may be to the network (e.g., the 5G network) and a data network.

WTRUs (e.g., all WTRUs), including an RG, may have a subscription identifier (e.g., a SUPI). Devices (e.g., non-3gpp devices), that connect through RG, may have an assigned device identity.

Communication from devices (e.g., non-3gpp devices) behind RG/WTRU may be tracked based on IP address/Prefix (IPv6). Devices may support an IPv6 mechanism for IP-based communication.

The network may determine that a device specific QoS treatment is not to be provided to a device associated with a specific device identifier. The network may make this determination when the device identifier is not recognized by the network. For example, the network may determine a device is not to be provided a device specific QoS treatment because a device identifier is not linked with a WTRU subscription or because the device identifier may not be associated with the PDU session that was used to send the DHCPv6 request. In an example (e.g., scenario) where the network determines that the device specific QoS treatment is not to be provided to a device associated with a specific device identifier, traffic of the device may be routed to and/or from the system (e.g., 5G system) without the device specific QoS treatment.

The RG may set up a PDU session to be used for user plane interaction by the devices behind the RG. The controlling SMF may act as a DHCPv6 server and configure the UPF to forward all DHCPv6 messages to the SMF.

Devices behind the RG may connect to the RG using a Point-to-Point (P2P) or Layer-2 (L2) mechanism. The RG may authenticate the devices. The devices behind the RG may use the DHCPv6 mechanism to obtain IP address/prefix before these devices can initiate user plane communication. The devices may send DHCPv6 messages to the RG. The RG may add device identity information in the DHCPv6 message. In examples, the RG may act as a DHCPv6 relay by adding the Remote ID option to the DHCPv6 request from the device. The Remote ID option may be set to a device identifier. The device identifier value may be formatted as a string, NAI, Enterprise name/ID, MAC Address, or Caller ID. In an example, it may be assumed that the RG has been provisioned/configured with the Device ID information. The RG may have been configured with information that may be used to select a device identifier for one or more devices connecting to it. In examples, a graphical user interface (GUI) that is associated with the RG may be used to indicate what device identifier is associated with a device. A device (e.g., each device) may be identified in the GUI with a MAC address. The GUI may be used to provide a MAC address to a device identifier (e.g., string) mapping.

The RG may (e.g., alternatively) be configured with a Device ID pool. The RG may be governed by a policy that may indicate a number of usable IDs but may not be concerned about specific devices. The RG may assign an available ID to a requesting device (e.g., first come, first serve basis). This may allow dynamic mapping for the RG to provide differentiated connectivity treatment more on demand. Network configuration may be used to control the device ID pool.

The RG may select a PDU session to transmit the DHCPv6 request. The RG may perform a URSP rule evaluation on the DHCPv6 request (e.g., based on the traffic descriptor of a first URSP rule) which may indicate that the RSDs of the first URSP rule are to be used for devices that are associated with a device identifier. RG may use the RSDs of the first URSP Rule to select a first PDU session that is associated with a first DNN/S-NSSAI combination. The traffic descriptor of the first URSP rule may (e.g., alternatively) indicate that all DHCPv6 traffic that carries the interface ID or remote ID option matches the URSP rule.

The RG may use the first PDU session to relay the DHCPv6 message to UPF. The UPF may forward the DHCPv6 message, with device identity to the SMF.

The SMF may retrieve the device ID from the DHCP request. The SMF may send the device identifier to the PCF and receive PCC Rules from the PCF. The PCF may use the device identifier as a data key to query the unified data management (UDM)/UDR and receive, in response to the query, QoS information that is associated with the device. The PCF may use the QoS information to derive the PCC Rules that are sent to the SMF. The PCC Rules may then be used by the SMF to derive QoS Rules for the device's traffic. The SMF may use (e.g., alternatively) the device identifier as a data key to query the UDM/UDR and receive, in response to the query, QoS information that is associated with the device. The SMF may then use the QoS information to derive QoS Rules for the device's traffic.

The SMF may record the device identifier in a call data record (CDR). If the Device ID information cannot be authenticated or recognized, the SMF may be informed by UDM/UDR or the PCF. The SMF may receive an indication from the UDM/UDR or the PCF that the device is not recognized, or the device is not entitled to receive specific QoS treatment.

The SMF may send a DHCPv6 response message to the RG, via the UPF, with a status code. The RG may process the status code and may perform one of more of the following actions: inform the devices about the status code and store the information; and if the device initiates communication, adjust URSP rules, and use a different PDU session for traffic unrelated to a device identity-based service.

If the SMF receives an indication that the device behind RG, identified by the Device Identifier is not recognized or the device behind RG is not entitled to receive specific QoS treatment, the SMF may send a DHCPv6 status code to the RG that indicates NoBinding (3). The status code may be interpreted by the RG as an indication that the device is not entitled to device specific QoS.

The RG may try to resend the DHCPv6 request with another device identifier from the Device ID pool, or no Device ID. The request may be sent in a NAS-SM message that indicates the identity of the PDU Session. The request may be sent to the SMF that serves the PDU Session. The Device ID pool refers to the Device IDs that are provisioned, or configured, in the RG. The RG may resend the DHCP request but without inserting ID this time for default treatment (e.g., best effort connectivity).

The RG may forward the DHCPv6 response to the device. Upon receiving a response that indicates that the DHCPV6 request was not successful, the device may attempt to send a second DHCPv6 request. Upon receiving the second DHCPv6 request, based on the first request being rejected, the RG may determine to forward the DHCPv6 request with no interface ID or remote ID.

The RG may select (e.g., again) a PDU session to transmit the DHCPv6 request. The RG may perform a URSP rule evaluation on the DHCPv6 request and, based on the traffic descriptor of a second URSP rule indicating that the RSDs of the second URSP Rule are not to be used for devices that are not associated with a device identifier, use the RSDs of the second URSP Rule to select a second PDU session that is associated with a second DNN/S-NSSAI combination.

The RG may use the second PDU session to relay the DHCPv6 message to the UPF. The UPF may forward the DHCPv6 message with the device identity to the SMF of the second PDU session.

In an example, the RG may be configured as a DHCPv6 relay and the SMF may be configured as a DHCPv6 server. A WTRU (e.g., RG) may establish a first PDU session to a first DNN/S-NSSAI combination. The WTRU may be configured to know that the first DNN/S-NSSAI combination is for forwarding traffic to and/or from devices that connect via the RG and support policy control for the traffic associated with individual devices based on device identity. The device identity may be exchanged using DHCPv6 mechanisms. The SMF of the first PDU session may be configured as a DHCPv6 server. The SMF may inform the PDU session anchor UPF to forward all DHCPv6 messages to the SMF.

A WTRU (e.g., RG) may establish a second PDU session to a second DNN/S-NSSAI combination. The WTRU may be configured to know that this second DNN/S-NSSAI combination is for forwarding traffic to and/or from devices that connect via the RG and are not to receive device specific QoS. The SMF of the second PDU session may still be configured as a DHCPv6 server. The second SMF may inform the PDU session anchor UPF to forward all DHCPv6 messages to the SMF.

The WTRU may be configured with QoS rules that are used to determine which PDU session should be used to forward device traffic that is associated with a device identifier and which PDU session should be used to forward device traffic that is not associated with a device identifier. In examples, the first PDU session may be used to forward device traffic that is associated with a device identifier. The second PDU session may be used to forward device traffic that is not associated with a device identifier.

The WTRU/RG may be configured to support DHCPv6 function and act as a relay for the devices behind the WTRU/RG. The devices behind the WTRU may use DHCPv6 to obtain (e.g., through the WTRU/RG acting as a DHCPv6 relay) an IP address/prefix from the SMF, which may act as a DHCPv6 server.

During PDU session establishment or PDU session modification, the WTRU may indicate to the SMF that this PDU session is used for forwarding (e.g., GW services) and device identity services. If a PDU session is configured for forwarding traffic to and/or from devices and device identity services are enabled using DHCPv6, the SMF may be configured as a DHCPv6 server. The SMF may inform the PDU session anchor UPF to forward all DHCPv6 messages to the SMF.

The WTRU/RG may be pre-provisioned with device identifiers and credentials that are associated with the devices. Examples of a credential may include a password, a key, and a certificate.

During a PDU session establishment, the SMF may configure the UPF to know which traffic is currently authorized for this PDU session. In examples, the SMF may indicate to the UPF which MAC Address and IP address/Prefix are allowed to send and/or receive traffic in the PDU session. During the PDU session Establishment, the SMF may indicate the UPF to forward all DHCPv6 messages received for this PDU session.

An SMF triggered device QoS update may be provided. Examples, such as two examples, options, or scenarios, may be provided. In a first example, which may be referred to as option 1, a SMF may initiate a QoS update via a PCF. In a second example, which may be referred to as option 2, a SMF may initiate a QoS update based on information that the SMF may obtain from the Unified Data Management (UDM)/User Data Repository (UDR).

In a first example, which may be referred to as option 1, the PCF may obtain QoS information from the UDM/UDR. FIG. 2 illustrates an example procedure for a DHCPv6 based QoS update via the PCF. For example, FIG. 2 may illustrate an example procedure that may occur after a WTRU establishes a PDU session for forwarding device traffic.

The example procedure shows how DHCPv6 messages, which may carry a device identifier, may be sent by the RG to the SMF through the UPF. Upon receiving the DHCPv6 message, the SMF may trigger the PCF to derive PCC rules that are based on the device identifier. Based on PCC rules for a specific device ID, the SMF may configure the UPF, WTRU, and RAN.

As shown in FIG. 2, at 0 the RG may establish a first PDU session. The PDU session establishment request may indicate that the PDU session will be used for forwarding device traffic. The PDU session establishment request may indicate that the SMF may be configured to act as DHCPv6 server and may configure the UPF to forward one or more (e.g., all) DHCPv6 messages. The PDU session establishment request may indicate that the RG is configured as a DHCP relay.

In examples, the PDU session Establishment request may include a DNN/S-NSSAI combination that is understood by the network as being used for traffic associated with devices that have a device identifier and expect device specific QoS treatment. The RG may be triggered to establish a PDU session after network registration. The RG may be triggered to establish this PDU session after network registration and after a request from an application (e.g., a GUI). The RG may be triggered to establish this PDU session after detecting traffic that comes from a device that the RG detects is associated with a device identifier. In examples, a traffic descriptor of a URSP rule may indicate that the RSDs of the URSP rule may be evaluated when traffic is detected from a device that is associated with a device identifier.

At 1, the device may authenticate itself and may connect to the WTRU/RG. The device may send an uplink packet, which may include a DHCPv6 message to the WTRU (e.g., RG). The DHCPv6 message may solicit, request or renew message. The WTRU/RG may add the device ID information to the request. In examples, the device ID information may be at least one of a device identifier, a port number, and interface number, a DHCPv6 Remote ID option, an Enterprise name/ID, a Caller ID, a User ID, a device identity included in a DHCPv6 message, a combination thereof, or the like. The device ID may include information that may be used to identify the device to the UDM/UDR server. The information may be part of the device identity. In examples, the device identity may include a domain identifier field. The information may be the domain identifier. The information may be an MNO identifier. The information may be a service provider identifier. The WTRU/RG may have been configured with the device identifier and the information that is used to identify the device to the UDM/UDR Server. The configuration of the device may have been performed by an application such as a GUI.

At 2, the WTRU/RG may relay the uplink packet in the first PDU session. The uplink packet is the DHCPv6 message with the added Interface ID and Remote ID. The uplink packet may be sent to the UPF. The uplink packet may be sent in the first PDU session which was previously established for forwarding device traffic.

At 3, the UPF may detect that the packet contains a DHCPv6 message and may decide to forward it to the SMF.

At 4, the UPF may forward the DHCPv6 message to the SMF. The DHCPv6 message may include device identity information. The SMF may be acting as a DHCP server.

At 5, the SMF may use the DHCPv6 message that is carried in the NAS-SM message to detect that the message is from a new device and that device identifier may need to be processed. The SMF may decide to retrieve device identifier information from the remote ID option field in the DHCPv6 message. The SMF may use the PDU Session ID of the NAS-SM message and a message type field of the NAS-SM message to determine which PDU Session the device identifier is associated with.

The SMF may retrieve device identity information from the DHCPv6 message. The device identity information may be in different forms like device identifier, interface ID, etc. If this is a DHCPv6 request message, the SMF may assign an IP address. The presence of the device ID in DHCPv6 message may trigger the SMF to activate policy control based on device identity. The SMF may check if policy information related to the device ID is available. If not, the SMF may initiate an option (e.g., the first option or the first example described herein) and may query the PCF for PCC rules (e.g., new or updated PCC rules) for the device behind the RG/WTRU.

At 6, the SMF may send a request message to the PCF, requesting new or updated policy/PCC rules for the device with a device ID by sending a message to the PCF. The message may include the IP address of the device. The message may include the interface number which may be a port number. The message may include the device identifier.

At 7, the PCF may receive the request message for new policy/PCC rules for a device with device ID. The PCF also may receive the WTRU/RG information with which the device is associated/connected.

The PCF may check if the device identity is linked to the subscription of the WTRU or an RG (e.g., a 5G-RG). Checking that the device identity is linked to the subscription of the WTRU or an RG (e.g., 5G-RG) may mean that the PCF may check if the device (or person) that is associated with the device identifier is allowed to use the subscription of the WTRU or the RG (e.g., 5G-RG) to send and/or receive data. The PCF may perform the check by sending a query to a UDM/UDR to verify that the device profile that is associated with the device identity has information stored that indicates that the device identity is linked to the SUPI of the WTRU or the RG (e.g., 5G-RG). In examples, the PCF may perform the check by sending a query to a UDM/UDR to verify that the subscription that is associated with the WTRU or the RG (e.g., 5G-RG) has information stored that indicates that the device identity is linked to the SUPI of the WTRU or the RG (e.g., 5G-RG).

The PCF may request device profile information from the UDM/UDR associated with the device ID, if the device ID is linked to the subscription of the WTRU/RG. The device profile may include information about at least one of the type of device, device capability, service, or DN (e.g., the device may be allowed to access, subscribed services, etc.).

At 8, the PCF may send a message to UDM/UDR to verify that the device ID is part of a device profile, which has valid QoS information stored in the UDR. If the device has valid QoS information stored in the UDR, the PCF may request to get the QoS information. The request message may include the device ID information.

At 9, the UDM/UDR may retrieve the device profile information. The UDM/UDR may respond to the PCF with the device profile QoS information.

At 10, If the PCF determines that the device identity and subscription are not linked, the PCF may inform the SMF that the device is not associated with the subscription. The SMF can configure UPF to block the device. The SMF may indicate the WTRU/RG to update its subscription or use a different PDU session for the device traffic.

If the device identity and subscription are linked and the PCF receives the device profile information, the PCF may create PCC rules based on the device profile information received from the UDM/UDR.

In examples, the PCC rule may specify that a flow, identified by an IP address and/or Interface ID of a device (traffic classifier, flow information AVP attribute value pair), may be steered to a DN based on a subscription in the device profile.

The PCC rule may include a Reference ID for a specific flow. The Reference ID may be a charging identifier. The charging identifier may be the device identifier. The charging identifier may include a value that the PCF has associated with the device identifier. A flow, identified by the IP address of a device, may be related to the device profile and device subscriptions. A service may be provided based on device profile information.

At 11, the PCF may send the PCC rules (e.g., the new/updated PCC rules) to the SMF, including the source IP address and device ID. The PCF may include a reference ID for the flow from the device. The message may also include a charging identifier, which may be the same as a device ID used while generating CDR.

At 12, the SMF, based on the received PCC rules, may configure the UPF to identify the devices based on the IP address (or MAC address) and provide device identity based services (e.g., the SMF may configure the UPF to identify a flow based on an IP address and steer it towards a DN or generate CDR for the flow and include the charging identifier in the CDR). The SMF may (e.g., alternatively) send a QoS rule to the WTRU that includes a device ID (e.g., in the traffic filter). The WTRU may associate traffic from this device ID with this QoS rule.

The SMF may notify the UPF whether traffic to and/or from the detected address is allowed. The notification may include the charging identifier. The UPF may include the charging identifier in CDRs that record information about the traffic sent to and/or from the detected address. The information in the CDRs may be used by the MNO to bill the service provider associated with the device identifier.

The SMF may select a status code to be sent to the WTRU/RG with the DHCPv6 response message.

At 13, the SMF may send the DHCPv6 response back (e.g., relay_response message) to RG with status code. If the status code is set to NoBinding or UnspecFail or another failure cause, the RG may block further traffic from the PDU from being sent in the PDU session.

At 14, the RG may receive the DHCPv6 response. If the DHCPv6 response included an error status code such as NoBinding or UnspecFail or other failure cause, the RG may begin to run a timer. As long as the timer is running, the RG may consider the device to not be associated with the device identifier. If the timer is running, any attempt by the device to send a DHCPv6 message may be forwarded to a different PDU session (e.g., a second PDU session) and may not include a remote ID field. If the device generates a DHCPv6 request after the timer has expired or after the de-registers and re-registers with the network, then the RG may attempt to send (e.g., send again) the DHCPv6 request in the first PDU session.

If the DHCPv6 response included no error status code such as NoBinding or UnspecFail or other failure cause, the RG may associate future traffic from the device with this PDU session (e.g., the first PDU session). At 15, the RG may forward the DHCP response to the device.

In a second example, which may be referred to as option 2, a SMF may initiate a QoS update based on information that the SMF may obtain from the Unified Data Management (UDM)/User Data Repository (UDR). In a second example, which may be referred to as option 2, the SMF may update QoS based on information that the SMF obtains from the UDM/UDR.

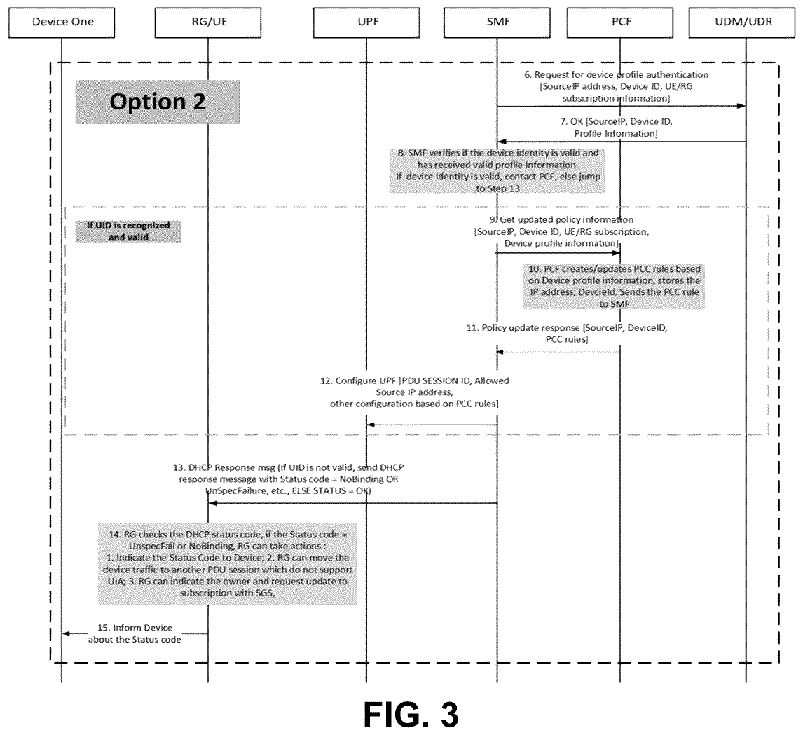

FIG. 3 illustrates an example procedure, which may be referred to as option 2. In an example, the example procedure shown in FIG. 3 may occur after 5 in FIG. 2. For example, upon receiving a DHCPv6 message, the SMF may query the UDM/UDR for device specific QoS Information.

Referring again to FIG. 3, the example procedure may be for a DHCPv6 based QoS configuration based on the SMF interacting with the UDM/UDR.

At 6, the SMF may determine the UDM/UDR and may send a request message to the UDM/UDR. The request may include the device identifier and may be a request to obtain device QoS information. The SMF may indicate to the UDM/UDR at least one of the following: the source IP address; or the device ID, which may be retrieved from the DHCPv6 message. In an example, the device ID may be at least one of a DHCPv6 Remote ID option, an enterprise name/ID, a Caller ID, a User ID, a combination thereof, or the like. The device ID may be used as device identity and indicated to UDM/UDR). The SMF may indicate to the UDM/UDR WTRU/RG information.

At 7, the UDM/UDR may receive the request message. The UDM may check if the device identity is linked to the subscription of the WTRU or the RG (e.g., 5G-RG). Checking that the device identity is linked to the subscription of the WTRU or RG (e.g., 5G-RG) may mean that the device (or user) that is associated with the device identifier is allowed to use the subscription of the WTRU or RG (e.g., 5G-RG) to send and/or receive data. The UDM/UDR may verify that the device profile that is associated with the device identity has information stored that indicates that the device identity is linked to the SUPI of the WTRU or RG (e.g., 5G-RG). In examples, the UDM/UDR may verify that the subscription that is associated with the WTRU or the RG (e.g., 5G-RG) has information stored that indicates that the device identity is linked to the SUPI of the WTRU or the RG (e.g., 5G-RG).

If the device identity can be recognized and is valid (e.g., it is linked to the subscription) then the UDM/UDR may inform the SMF that the device ID is valid and includes device profile information. The device profile information may include the QoS requirements for the traffic of the device.

The UDM/UDR may indicate to the SMF that the device ID is invalid and/or not linked to the subscription.

At 8, the SMF may verify the response from the UDM/UDR to check if the device identity is valid and/or recognized.

At 9, if the device identity is valid, the SMF may obtain PCC rules. For example, the SMF may obtain PPC rules from the PCF such as shown at 6, 7, 10 and 11 in FIG. 2.

For example, the SMF may configure the UPF as described at 12 in FIG. 2. The SMF may respond to the WTRU as described at 13 in FIG. 2. The RG may process the DHCP response as described at 14 in FIG. 2. The RG may forward the DHCP response to the device as described at 15 in FIG. 2.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit/receive unit (WTRU), the WTRU comprising:
a processor, wherein the processor is configured to:
establish a first Protocol Data Unit (PDU) session to a first network node;
establish a second PDU session with a second network node;
receive a first message from a device, wherein the first message indicates a first Dynamic Host Configuration protocol (DHCP) request;
determine a device identifier associated with the DHCP request based on configuration information and a characteristic of the DHCP request;
generate a second message, wherein the second message indicates the DHCP request and a remote identification (ID) option value, wherein the remote ID option value is set to the device identifier; and
send the second message to the first network node using the first PDU session.
receive a third message from the network node, wherein the third message indicates a DHCP response, and wherein the DHCP response indicates an error code;
send a fourth message to the device, wherein the fourth message indicates the DHCP response;
receive a fifth message from the device, wherein the fifth message indicates a second DHCP request;
determine that the second DHCP request is associated with the error code; and
send a sixth message to the second network node using the second PDU session.

2. The WTRU of claim 1, wherein the processor is further configured to select the second PDU session based on a determination that the first PDU session is associated with the error code.

3. The WTRU of claim 1, wherein the processor is further configured to:
receive an seventh message from the second node, wherein the seventh message indicates a second DHCP response, and wherein the DHCP response indicates an acknowledgement that the sixth message was received; and
send a eighth message to the device, wherein the eighth message indicates the second DHCP response.

4. The WTRU of claim 2, wherein the processor is further configured to receive data from the second network node using the second PDU session and send the data to the device.

5. The WTRU of claim 2, wherein the processor is further configured to receive data from the device and send the data to the second network node using the second PDU session.

6. The WTRU of claim 1, wherein the processor is further configured to determine the configuration information.

7. The WTRU of claim 1, wherein the processor is further configured to receive the configuration information via a graphical user interface (GUI).

8. The WTRU of claim 1, wherein the processor being configured to send the second message to the network node using the PDU session comprises the processor being configured to:
select the first PDU session to be used for sending the second message based on the configuration information; and
send the second message to the first network node using the selected PDU session.

9. The WTRU of claim 1, wherein the error code comprises at least one of an indication of a failure cause, an indication that the device identifier is not recognized, an indication that the device identifier is not linked to a subscription associated with the WTRU, an indication that the device identifier is not permitted to access the first PDU session, or an indication that the device identifier is not permitted to access the second PDU session.

10. The WTRU of claim 1, wherein the processor is further configured to determine a first configuration information, wherein the first configuration information is associated with a first Data Network Name (DNN) and a second Single-Network Slice Selection Assistance Information (S-NSSAI), and wherein a first combination of the first DNN and the first S-NSSAI indicates one or more devices that request at least one of a device specific Quality of Service (QoS) or a device identifier.

11. The WTRU of claim 10, wherein the processor is further configured to determine configuration information, wherein the configuration information is associated with a second DNN and a second S-NSSAI, and wherein a combination of the second DNN and the second S-NSSAI indicates one or more devices that are not associated with at least a device specific QoS or a device identifier.

12. A method performed by a wireless transmit/receive unit (WTRU), the method comprising:
establishing a Protocol Data Unit (PDU) session to a first network node;
establishing a second PDU session with a second network node;
receiving a first message from a device, wherein the first message indicates a first Dynamic Host Configuration protocol (DHCP) request;
determining a device identifier associated with the DHCP request based on configuration information and a characteristic of the DHCP request;
generating a second message, wherein the second message indicates the DHCP request and a remote identification (ID) option value, wherein the remote ID option value is set to the device identifier;
sending the second message to the first network node using the first PDU session;
receiving a fifth message from the device, wherein the fifth message indicates a second DHCP request;
determining that the second DHCP request is associated with the error code; and
sending a sixth message to the second network node using the second PDU session.

13. The method of claim 12, wherein the method further comprises selecting the second PDU session based on a determination that the first PDU session is associated with the error code.

14. The method of claim 12, wherein the DHCP response is a first DHCP response, and wherein the method further comprises:
receiving an seventh message from the second node, wherein the seventh message indicates a second DHCP response, and wherein the DHCP response indicates an acknowledgement that the sixth message was received; and
sending a eighth message to the device, wherein the eighth message indicates the second DHCP response.

15. The method of claim 14, wherein the method further comprises receiving data from the second network node using the second PDU session and sending the data to the device.

16. The method of claim 15, wherein the method further comprises receiving data from the device and sending the data to the second network node using the second PDU session.

17. The method of claim 12, wherein the method further comprises determining the configuration information.

18. The method of claim 12, wherein the method further comprises receiving the configuration information via a graphical user interface (GUI).
